(19) United States
(12) Patent Application Publication
(10) Pub. No.: US 2007/0109955 A1
(43) Pub. Date: May 17, 2007

(54) Power control in MIMO transceiver

(75) Inventors: Rajendra Tushar Moorti, Mountain View, CA (US); Jason A. Trachewsky, Menlo Park, CA (US)

Correspondence Address: GARLICK HARRISON & MARKISON, P.O. BOX 160727, AUSTIN, TX, 78716-0727, US

(73) Assignee: Broadcom Corporation, a California Corporation, Irvine, CA (US)

(21) Appl. No.: 11/542,913

(22) Filed: Oct. 4, 2006

Related U.S. Application Data
(60) Provisional application No. 60/735,499, filed on Nov. 11, 2005.

(51) Int. Cl. H04J 11/00; H04B 7/216

(52) U.S. Cl. 370/206; 370/335

(57) ABSTRACT

A method of controlling power levels on a plurality of transmit streams in a single radio transceiver includes, for each of the plurality of transmit streams, detecting an output power level and sampling the output power level, digitizing the sample output power level, producing the digitized sample to a baseband processor. The baseband processor is operable to perform rate based compensation on the digital sample, to integrate and dump a plurality of digitized samples over a period that exceeds a transmission frame period to produce an average value over a specified number of samples. Thereafter, the processor is operable to convert the integrated plurality of digitized samples to a normalized value and to comparing the normalized value to a target value to generate a power index value to determine an output power level with rate based compensation.

### CROSS-REFERENCE TO RELATED APPLICATION

The present application claims priority pursuant to 35 U.S.C. §119 (e) to U.S. Provisional Application Ser. No. 60/735,499, filed Nov. 11, 2005, which is hereby incorporated by reference in its entirety.

### BACKGROUND

1. Technical Field

The present invention relates to wireless communications and, more particularly, to integrated circuit based voltage regulators.

2. Related Art

Communication systems are known to support wireless and wire lined communications between wireless and/or wire lined communication devices. Such communication systems range from national and/or international cellular telephone systems to the Internet to point-to-point in-home wireless networks. Each type of communication system is constructed, and hence operates, in accordance with one or more communication standards. For instance, wireless communication systems may operate in accordance with one or more standards, including, but not limited to, IEEE 802.11, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), and/or variations thereof.

Depending on the type of wireless communication system, a wireless communication device, such as a cellular telephone, two-way radio, personal digital assistant (PDA), personal computer (PC), laptop computer, home entertainment equipment, etc., communicates directly or indirectly with other wireless communication devices. For direct communications (also known as point-to-point communications), the participating wireless communication devices tune their receivers and transmitters to the same channel or channels (e.g., one of a plurality of radio frequency (RF) carriers of the wireless communication system) and communicate over that channel(s). For indirect wireless communications, each wireless communication device communicates directly with an associated base station (e.g., for cellular services) and/or an associated access point (e.g., for an in-home or in-building wireless network) via an assigned channel. To complete a communication connection between the wireless communication devices, the associated base stations and/or associated access points communicate with each other directly, via a system controller, via a public switched telephone network (PSTN), via the Internet, and/or via some other wide area network.

Each wireless communication device includes a built-in radio transceiver (i.e., receiver and transmitter) or is coupled to an associated radio transceiver (e.g., a station for in-home and/or in-building wireless communication networks, RF modem, etc.). As is known, the transmitter includes a data modulation stage, one or more intermediate frequency stages, and a power amplifier stage. The data modulation stage converts raw data into baseband signals in accordance with the particular wireless communication standard. The one or more intermediate frequency stages mix the baseband signals with one or more local oscillations to produce RF signals. The power amplifier stage amplifies the RF signals prior to transmission via an antenna.

Typically, the data modulation stage is implemented on a baseband processor chip, while the intermediate frequency (IF) stages and power amplifier stage are implemented on a separate radio processor chip. Historically, radio integrated circuits have been designed using bipolar circuitry, allowing for large signal swings and linear transmitter component behavior. Therefore, many legacy baseband processors employ analog interfaces that communicate analog signals to and from the radio processor.

In a MIMO system, power control can be based on a plurality of factors including modulation type and data rate, a number of simultaneous streams being transmitted, and other similar factors. A need exists, therefore, for power control and selection in MIMO radio transceivers.

### SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

A better understanding of the present invention can be obtained when the following detailed description of the preferred embodiment is considered with the following drawings, in which:

FIG. 1 is a functional block diagram illustrating a communication system that includes circuit devices and network elements and operation thereof according to one embodiment of the invention;

FIG. 2 is a schematic block diagram illustrating a wireless communication host device and an associated radio;

FIG. 3 is a schematic block diagram illustrating a wireless communication device that includes the host device and an associated radio;

FIG. 4 is a structure and corresponding method of controlling power levels on a plurality of transmit streams in a single radio transceiver according to one embodiment of the invention;

FIG. 5 is a functional block diagram of a transmit power control circuit formed according to one embodiment of the invention;

FIG. 6 is a functional block diagram of a transmit power detect block TX power adjustment block 198 according to one embodiment of the invention;

FIG. 7 is a diagram that illustrates one aspect of the embodiments of the present invention;

FIG. 8 is a functional block diagram that illustrates logic for determining a transmit power index according to one embodiment of the invention;

FIG. 9 is a diagram illustrating a process utilized in one embodiment of the present invention; and

FIG. 10 is a diagram illustrating a method according to one embodiment of the invention for determining transmit gain settings and transmit compensation settings for I/Q imbalance and LO feedthrough according to one embodiment of the invention for one or more cores.

### DETAILED DESCRIPTION OF THE DRAWINGS

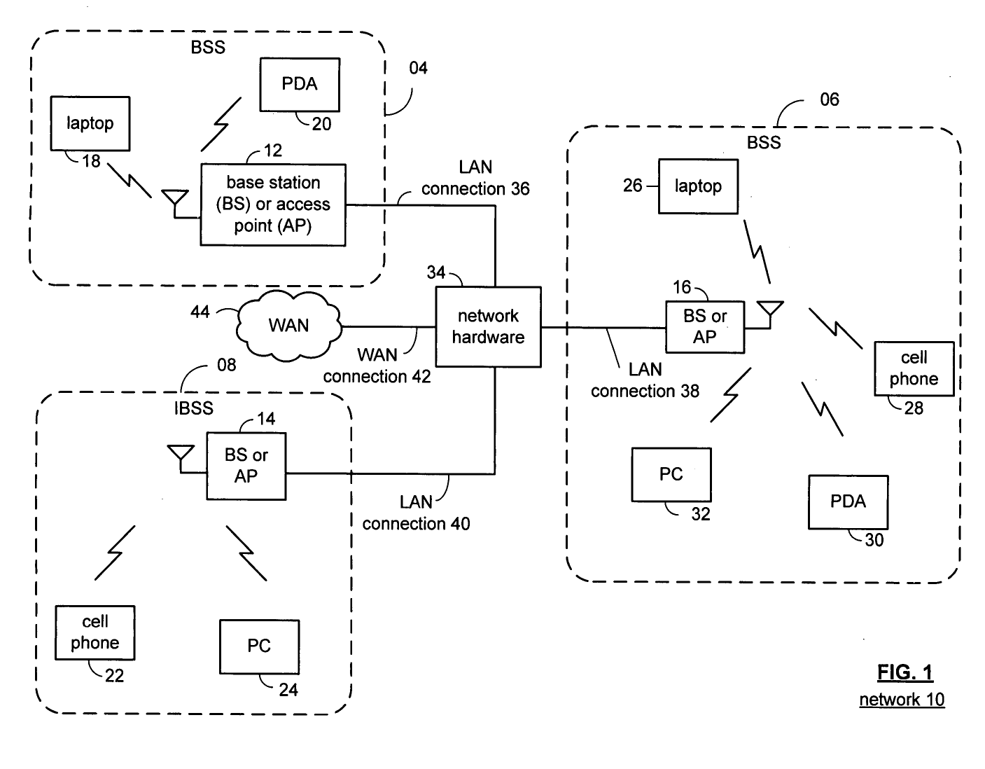

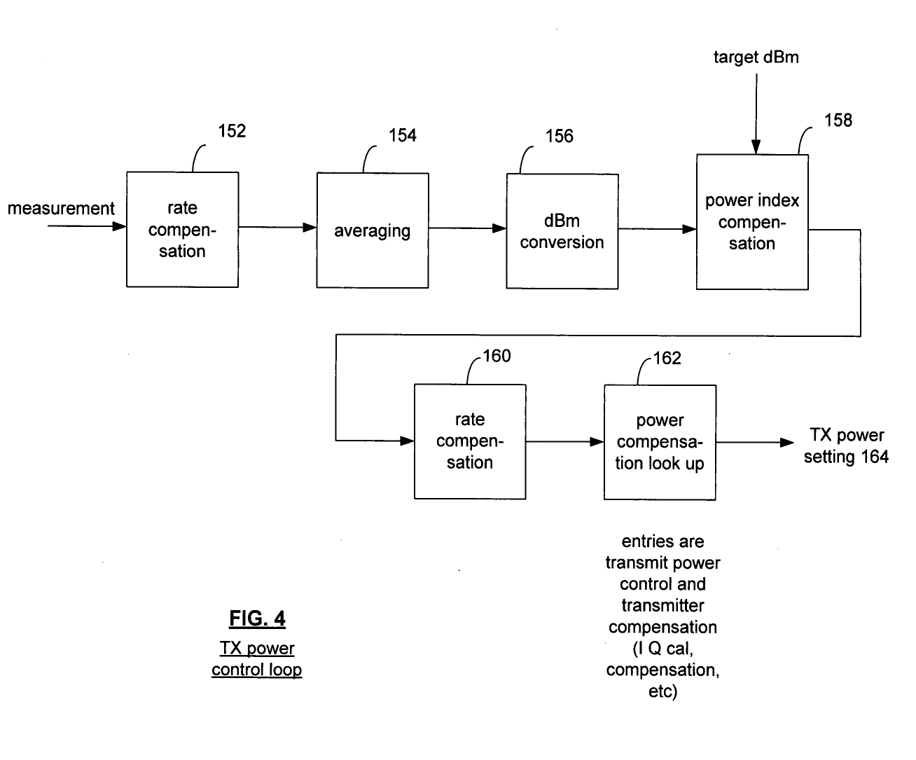

FIG. 1 is a functional block diagram illustrating a communication system that includes circuit devices and network elements and operation thereof according to one embodiment of the invention. More specifically, a plurality of network service areas 04, 06 and 08 are a part of a network 10. Network 10 includes a plurality of base stations or access points (APs) 12-16, a plurality of wireless communication devices 18-32 and a network hardware component 34. The wireless communication devices 18-32 may be laptop computers 18 and 26, personal digital assistants 20 and 30, personal computers 24 and 32 and/or cellular telephones 22 and 28. The details of the wireless communication devices will be described in greater detail with reference to FIGS. 4-9.

The base stations or APs 12-16 are operably coupled to the network hardware component 34 via local area network (LAN) connections 36, 38 and 40. The network hardware component 34, which may be a router, switch, bridge, modem, system controller, etc., provides a wide area network (WAN) connection 42 for the communication system 10 to an external network element such as WAN 44. Each of the base stations or access points 12-16 has an associated antenna or antenna array to communicate with the wireless communication devices in its area. Typically, the wireless communication devices 18-32 register with the particular base station or access points 12-16 to receive services from the communication system 10. For direct connections (i.e., point-to-point communications), wireless communication devices communicate directly via an allocated channel.

Typically, base stations are used for cellular telephone systems and like-type systems, while access points are used for in-home or in-building wireless networks. Regardless of the particular type of communication system, each wireless communication device includes a built-in radio and/or is coupled to a radio.

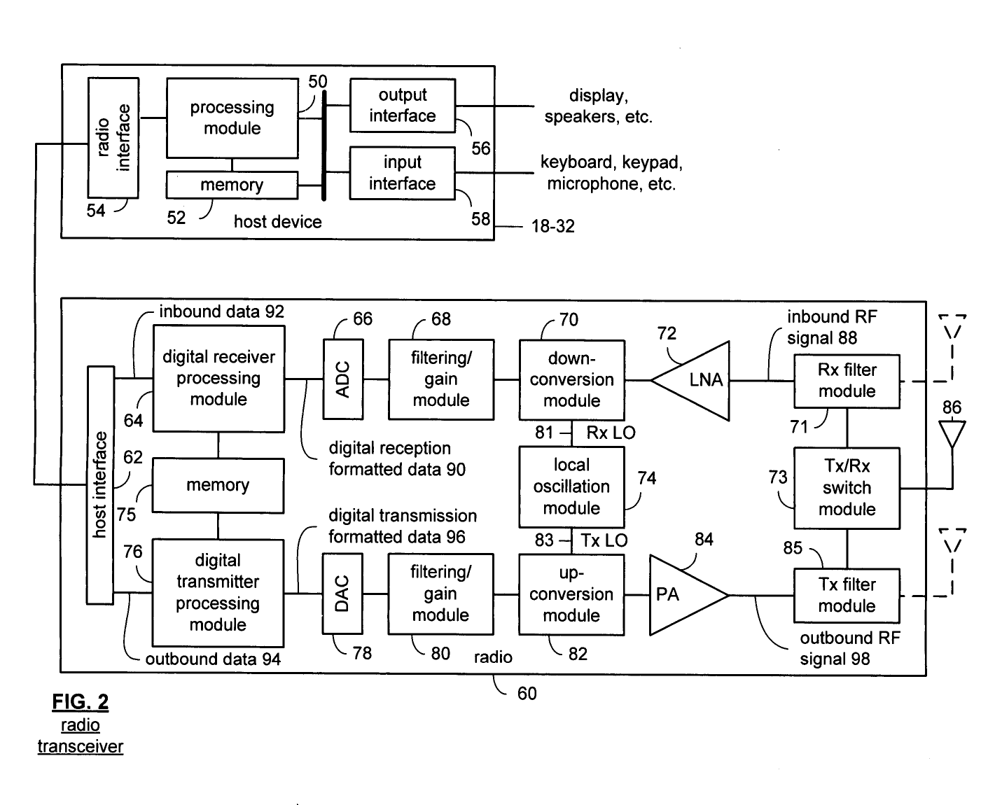

FIG. 2 is a schematic block diagram illustrating a wireless communication host device 18-32 and an associated radio 60. For cellular telephone hosts, radio 60 is a built-in component. For personal digital assistants hosts, laptop hosts, and/or personal computer hosts, the radio 60 may be built-in or an externally coupled component.

As illustrated, wireless communication host device 18-32 includes a processing module 50, a memory 52, a radio interface 54, an input interface 58 and an output interface 56. Processing module 50 and memory 52 execute the corresponding instructions that are typically done by the host device. For example, for a cellular telephone host device, processing module 50 performs the corresponding communication functions in accordance with a particular cellular telephone standard.

Radio interface 54 allows data to be received from and sent to radio 60. For data received from radio 60 (e.g., inbound data), radio interface 54 provides the data to processing module 50 for further processing and/or routing to output interface 56. Output interface 56 provides connectivity to an output device such as a display, monitor, speakers, etc., such that the received data may be displayed. Radio interface 54 also provides data from processing module 50 to radio 60. Processing module 50 may receive the outbound data from an input device such as a keyboard, keypad, microphone, etc., via input interface 58 or generate the data itself. For data received via input interface 58, processing module 50 may perform a corresponding host function on the data and/or route it to radio 60 via radio interface 54.

Radio 60 includes a host interface 62, a digital receiver processing module 64, an analog-to-digital converter 66, a filtering/gain module 68, a down-conversion module 70, a low noise amplifier 72, a receiver filter module 71, a transmitter/receiver (Tx/Rx) switch module 73, a local oscillation module 74, a memory 75, a digital transmitter processing module 76, a digital-to-analog converter 78, a filtering/gain module 80, an up-conversion module 82, a power amplifier 84, a transmitter filter module 85, and an antenna 86 operatively coupled as shown. The antenna 86 is shared by the transmit and receive paths as regulated by the Tx/Rx switch module 73. The antenna implementation will depend on the particular standard to which the wireless communication device is compliant.

Digital receiver processing module 64 and digital transmitter processing module 76, in combination with operational instructions stored in memory 75, execute digital receiver functions and digital transmitter functions, respectively. The digital receiver functions include, but are not limited to, demodulation, constellation demapping, decoding, and/or descrambling. The digital transmitter functions include, but are not limited to, scrambling, encoding, constellation mapping, and modulation. Digital receiver and transmitter processing modules 64 and 76, respectively, may be implemented using a shared processing device, individual processing devices, or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions.

Memory 75 may be a single memory device or a plurality of memory devices. Such a memory device may be a read-only memory, random access memory, volatile memory, non-volatile memory, static memory, dynamic memory, flash memory, and/or any device that stores digital information. Note that when digital receiver processing module 64 and/or digital transmitter processing module 76 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry. Memory 75 stores, and digital receiver processing module 64 and/or digital transmitter processing module 76 executes, operational instructions corresponding to at least some of the functions illustrated herein.

In operation, radio 60 receives outbound data 94 from wireless communication host device 18-32 via host interface 62. Host interface 62 routes outbound data 94 to digital transmitter processing module 76, which processes outbound data 94 in accordance with a particular wireless communication standard or protocol (e.g., IEEE 802.11(a), IEEE 802.11b, Bluetooth, etc.) to produce digital transmission formatted data 96. Digital transmission formatted data 96 will be a digital baseband signal or a digital low IF signal, where the low IF typically will be in the frequency range of one hundred kilohertz to a few megahertz.

Digital-to-analog converter 78 converts digital transmission formatted data 96 from the digital domain to the analog domain. Filtering/gain module 80 filters and/or adjusts the gain of the analog baseband signal prior to providing it to up-conversion module 82. Up-conversion module 82 directly converts the analog baseband signal, or low IF signal, into an RF signal based on a transmitter local oscillation 83 provided by local oscillation module 74. Power amplifier 84 amplifies the RF signal to produce an outbound RF signal 98, which is filtered by transmitter filter module 85. The antenna 86 transmits outbound RF signal 98 to a targeted device such as a base station, an access point and/or another wireless communication device.

Radio 60 also receives an inbound RF signal 88 via antenna 86, which was transmitted by a base station, an access point, or another wireless communication device. The antenna 86 provides inbound RF signal 88 to receiver filter module 71 via Tx/Rx switch module 73, where Rx filter module 71 bandpass filters inbound RF signal 88. The Rx filter module 71 provides the filtered RF signal to low noise amplifier 72, which amplifies inbound RF signal 88 to produce an amplified inbound RF signal. Low noise amplifier 72 provides the amplified inbound RF signal to down-conversion module 70, which directly converts the amplified inbound RF signal into an inbound low IF signal or baseband signal based on a receiver local oscillation 81 provided by local oscillation module 74. Down-conversion module 70 provides the inbound low IF signal or baseband signal to filtering/gain module 68. Filtering/gain module 68 may be implemented in accordance with the teachings of the present invention to filter and/or attenuate the inbound low IF signal or the inbound baseband signal to produce a filtered inbound signal.

Analog-to-digital converter 66 converts the filtered inbound signal from the analog domain to the digital domain to produce digital reception formatted data 90. Digital receiver processing module 64 decodes, descrambles, demaps, and/or demodulates digital reception formatted data 90 to recapture inbound data 92 in accordance with the particular wireless communication standard being implemented by radio 60. Host interface 62 provides the recaptured inbound data 92 to the wireless communication host device 18-32 via radio interface 54.

As one of average skill in the art will appreciate, the wireless communication device of FIG. 2 may be implemented using one or more integrated circuits. For example, the host device may be implemented on a first integrated circuit, while digital receiver processing module 64, digital transmitter processing module 76 and memory 75 may be implemented on a second integrated circuit, and the remaining components of radio 60, less antenna 86, may be implemented on a third integrated circuit. As an alternate example, radio 60 may be implemented on a single integrated circuit. As yet another example, processing module 50 of the host device and digital receiver processing module 64 and digital transmitter processing module 76 may be a common processing device implemented on a single integrated circuit.

Memory 52 and memory 75 may be implemented on a single integrated circuit and/or on the same integrated circuit as the common processing modules of processing module 50, digital receiver processing module 64, and digital transmitter processing module 76. As will be described, it is important that accurate oscillation signals are provided to mixers and conversion modules. A source of oscillation error is noise coupled into oscillation circuitry through integrated circuitry biasing circuitry. One embodiment of the present invention reduces the noise by providing a selectable pole low pass filter in current mirror devices formed within the one or more integrated circuits.

Local oscillation module 74 includes circuitry for adjusting an output frequency of a local oscillation signal provided therefrom. Local oscillation module 74 receives a frequency correction input that it uses to adjust an output local oscillation signal to produce a frequency corrected local oscillation signal output. While local oscillation module 74, up-conversion module 82 and down-conversion module 70 are implemented to perform direct conversion between baseband and RF, it is understood that the principles herein may also be applied readily to systems that implement an intermediate frequency conversion step at a low intermediate frequency.

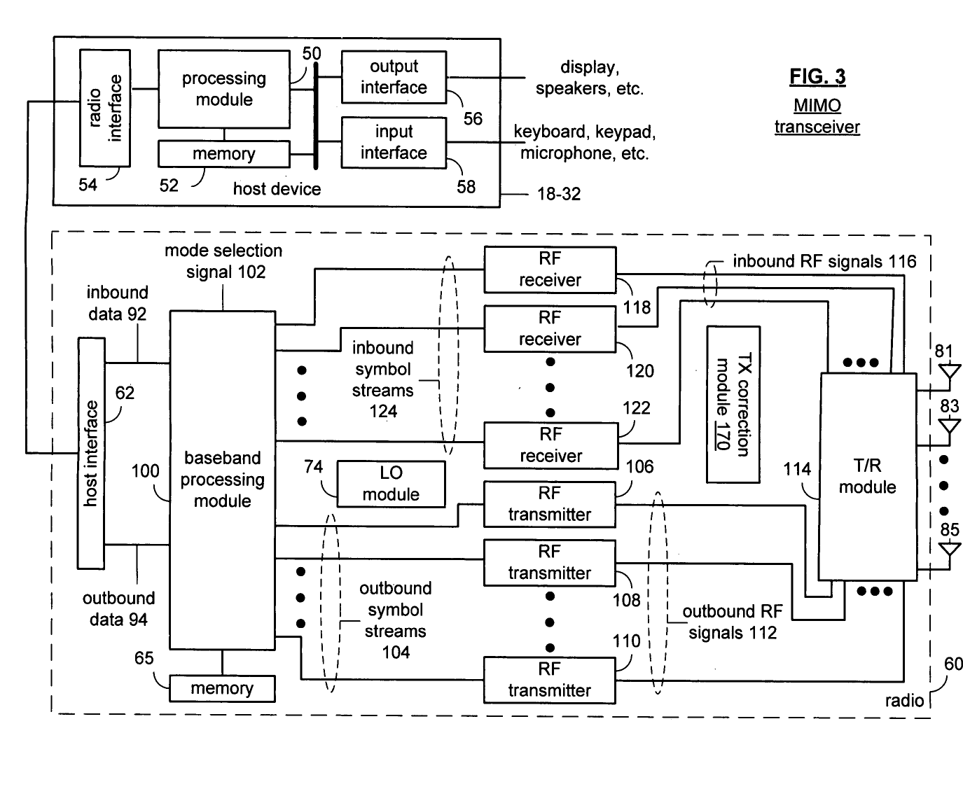

FIG. 3 is a schematic block diagram illustrating a wireless communication device that includes the host device 18-32 and an associated radio 60. For cellular telephone hosts, the radio 60 is a built-in component. For personal digital assistants hosts, laptop hosts, and/or personal computer hosts, the radio 60 may be built-in or an externally coupled component.

As illustrated, the host device 18-32 includes a processing module 50, memory 52, radio interface 54, input interface 58 and output interface 56. The processing module 50 and memory 52 execute the corresponding instructions that are typically done by the host device. For example, for a cellular telephone host device, the processing module 50 performs the corresponding communication functions in accordance with a particular cellular telephone standard.

The radio interface 54 allows data to be received from and sent to the radio 60. For data received from the radio 60 (e.g., inbound data), the radio interface 54 provides the data to the processing module 50 for further processing and/or routing to the output interface 56. The output interface 56 provides connectivity to an output display device such as a display, monitor, speakers, etc., such that the received data may be displayed. The radio interface 54 also provides data from the processing module 50 to the radio 60. The processing module 50 may receive the outbound data from an input device such as a keyboard, keypad, microphone, etc., via the input interface 58 or generate the data itself. For data received via the input interface 58, the processing module 50 may perform a corresponding host function on the data and/or route it to the radio 60 via the radio interface 54.

Radio 60 includes a host interface 62, a baseband processing module 100, memory 65, a plurality of radio frequency (RF) transmitters 106-110, a transmit/receive (T/R) module 114, a plurality of antennas 81-85, a plurality of RF receivers 118-120, and a local oscillation module 74. The baseband processing module 100, in combination with operational instructions stored in memory 65, executes digital receiver functions and digital transmitter functions, respectively. The digital receiver functions include, but are not limited to, digital intermediate frequency to baseband conversion, demodulation, constellation demapping, decoding, de-interleaving, fast Fourier transform, cyclic prefix removal, space and time decoding, and/or descrambling. The digital transmitter functions include, but are not limited to, scrambling, encoding, interleaving, constellation mapping, modulation, inverse fast Fourier transform, cyclic prefix addition, space and time encoding, and digital baseband to IF conversion. The baseband processing module 100 may be implemented using one or more processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory 65 may be a single memory device or a plurality of memory devices. Such a memory device may be a read-only memory, random access memory, volatile memory, non-volatile memory, static memory, dynamic memory, flash memory, and/or any device that stores digital information. Note that when the baseband processing module 100 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

In operation, the radio 60 receives outbound data 94 from the host device via the host interface 62. The baseband processing module 100 receives the outbound data 94 and, based on a mode selection signal 102, produces one or more outbound symbol streams 104. The mode selection signal 102 will indicate a particular mode of operation that is compliant with one or more specific modes of the various IEEE 802.11 standards. For example, the mode selection signal 102 may indicate a frequency band of 2.4 GHz, a channel bandwidth of 20 or 22 MHz and a maximum bit rate of 54 megabits-per-second. In this general category, the mode selection signal will further indicate a particular rate ranging from 1 megabit-per-second to 54 megabits-per-second. In addition, the mode selection signal will indicate a particular type of modulation, which includes, but is not limited to, Barker Code Modulation, BPSK, QPSK, CCK, 16 QAM and/or 64 QAM. The mode selection signal 102 may also include a code rate, a number of coded bits per subcarrier (NBPSC), coded bits per OFDM symbol (NCBPS), and/or data bits per OFDM symbol (NDBPS). The mode selection signal 102 may also indicate a particular channelization for the corresponding mode that provides a channel number and corresponding center frequency. The mode selection signal 102 may further indicate a power spectral density mask value and a number of antennas to be initially used for a MIMO communication.

The baseband processing module 100, based on the mode selection signal 102 produces one or more outbound symbol streams 104 from the outbound data 94. For example, if the mode selection signal 102 indicates that a single transmit antenna is being utilized for the particular mode that has been selected, the baseband processing module 100 will produce a single outbound symbol stream 104. Alternatively, if the mode selection signal 102 indicates 2, 3 or 4 antennas, the baseband processing module 100 will produce 2, 3 or 4 outbound symbol streams 104 from the outbound data 94.

Depending on the number of outbound symbol streams 104 produced by the baseband processing module 100, a corresponding number of the RF transmitters 106-110 will be enabled to convert the outbound symbol streams 104 into outbound RF signals 112. In general, each of the RF transmitters 106-110 includes a digital filter and upsampling module, a digital-to-analog conversion module, an analog filter module, a frequency up conversion module, a power amplifier, and a radio frequency bandpass filter. The RF transmitters 106-110 provide the outbound RF signals 112 to the transmit/receive module 114, which provides each outbound RF signal to a corresponding antenna 81-85.

When the radio 60 is in the receive mode, the transmit/receive module 114 receives one or more inbound RF signals 116 via the antennas 81-85 and provides them to one or more RF receivers 118-122. The RF receiver 118-122 converts the inbound RF signals 116 into a corresponding number of inbound symbol streams 124. The number of inbound symbol streams 124 will correspond to the particular mode in which the data was received. The baseband processing module 100 converts the inbound symbol streams 124 into inbound data 92, which is provided to the host device 18-32 via the host interface 62.

As one of average skill in the art will appreciate, the wireless communication device of FIG. 3 may be implemented using one or more integrated circuits. For example, the host device may be implemented on a first integrated circuit, the baseband processing module 100 and memory 65 may be implemented on a second integrated circuit, and the remaining components of the radio 60, less the antennas 81-85, may be implemented on a third integrated circuit. As an alternate example, the radio 60 may be implemented on a single integrated circuit. As yet another example, the processing module 50 of the host device and the baseband processing module 100 may be a common processing device implemented on a single integrated circuit. Further, the memory 52 and memory 65 may be implemented on a single integrated circuit and/or on the same integrated circuit as the common processing modules of processing module 50 and the baseband processing module 100. In a typical MIMO radio transceiver system, a transmitter is operable to communicate with a receiver over a plurality of antennas as is shown in FIG. 3.

Referring now to FIG. 4, a structure and corresponding method of controlling power levels on a plurality of transmit streams in a single radio transceiver. The method comprises, for each of the plurality of transmit streams, detecting (measuring) an output power level and sampling the output power level. The sampled output power is produced to digital logic and, more specifically, to a rate compensation block 152 that is operable to adjust the measured values based upon rate, modulation type, and other similar aspects. This step thus includes digitizing the sample output power level and producing the digitized sample to a baseband processor. Within the baseband processor, the rate based compensation is performed on the digital sample. The method further includes integrating and dumping a plurality of digitized samples over a period that exceeds a transmission frame period by an averaging block 154 to produce an integrated plurality of digitized samples to a dBm conversion block 156 that normalizes the received averaged (integrated) values. In the described embodiment, dBm conversion block 156 converts the digitized samples received from block averaging block 154 into a decibel value in dBm. The decibel value produced by dBm conversion block 156 then is compared to a target decibel value in a power index compensation block 158 which produces power index compensation values based upon the decibel values received from dBm conversion block 156, the target decibel value and upon error readings of prior index values. The power index compensation values are then adjusted according to a transmission rate by rate compensation block 160. The rate adjusted compensation is the produced to a power compensation look up block 162 that produces a transmit power settings that is adjusted for transmission rate and characteristics. The method includes comparing the normalized value to a target value to generate a power index value that will result in the normalized value being substantially equal to the target value. Thereafter, the method includes determining an output power level based upon the power index value and performing perform rate based compensation for the determined output power level and producing a TX power setting signal 164. Stated differently, the output power level is adjusted based upon factors such as the number of streams being transmitted, modulation type and data rate, etc., based upon determined compensation levels.

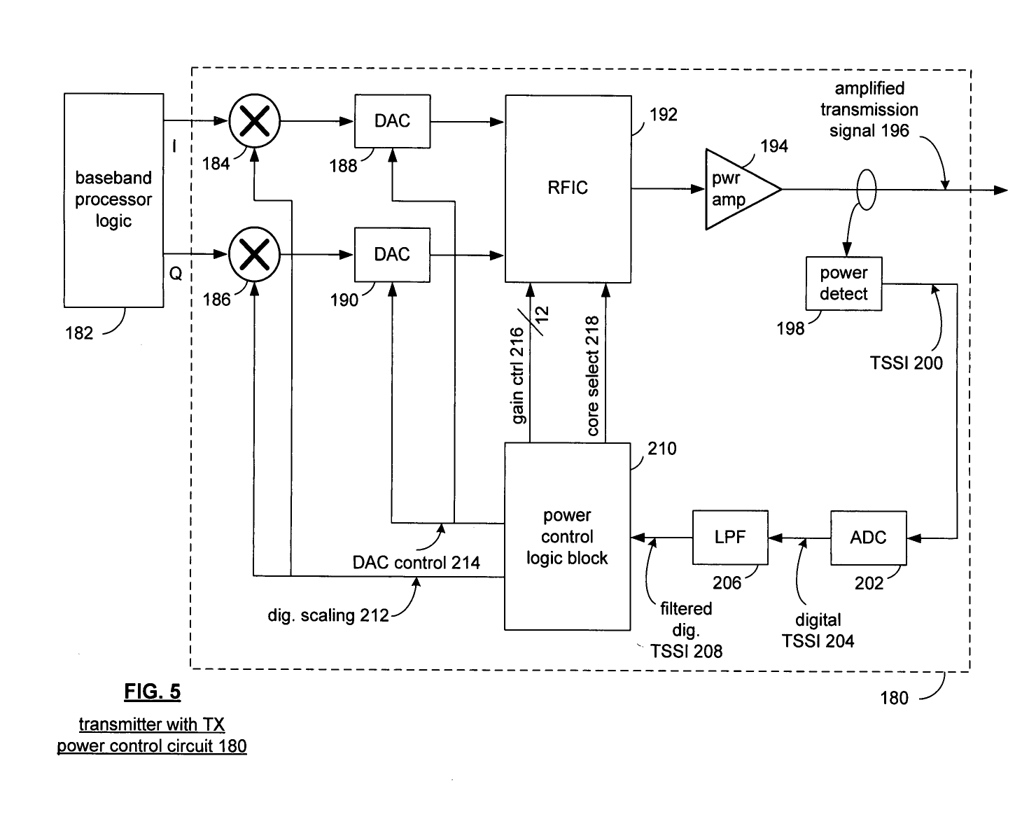

FIG. 5 is a functional block diagram of a transmit power control circuit formed according to one embodiment of the invention. A transmit (TX) power control circuit transmitter with TX power control circuit 180 is operably disposed to receive in-phase (i) and quadrature (Q) phase outgoing signals from baseband processor logic 182. The inputs to transmitter with TX power control circuit 180 are received by gain scaling element 184 and gain scaling element 186 for the I and Q phases are produced to gain scaling element 184 and gain scaling element 186. Gain scaling element 184 and gain scaling element 186, as will be described below, also receive a digital scaling signal 212 which is used to scale the I and Q phase signals received by gain scaling element 184 and gain scaling element 186. Gain scaling element 184 and gain scaling element 186 produce scaled I and Q outgoing signals to DAC 188 and DAC 190 which, in turn, produce continuous waveform I and Q outgoing signals to a radio frequency integrated circuit (RFIC) 192. RFIC 192 then produces a continuous waveform signal at an upconverted frequency (radio frequency) to power amp 194. The continuous waveform signal produced by RFIC 192 includes the I and Q outgoing signals. Power amp 194 subsequently produces amplified transmission signal 196 for wireless transmission from an antenna.

TX power adjustment block 198 measures (monitors) outgoing power levels of amplified transmission signal 196 and produces a transmission signal strength indication (TSSI) TSSI signal 200 to an analog-to-digital converter (ADC) 202. ADC 202 subsequently produces digital TSSI signal 204 to low pass filter 206 which, in turn, produces filtered digital TSSI signal 208 to power control logic block 210. Power control logic block 210 then produces digital scaling signal 212, DAC control signal 214, gain control signal 216 and core select signal 218. The digital scaling signal 212, the DAC control signal and the gain control signal 216 are based on the filtered digital TSSI signal 208 as will be described in greater detail below in relation to discussions relating to the power control circuit power control logic block 210.

In operation, baseband processor logic 182 produces outgoing digital signals to digital gain scaling element 184 and digital gain scaling element 186. Digital scaling elements 184 and 186 produce scaled digital signal outputs having a magnitude that is based at least in part upon digital scaling signal 212 produced by power control logic block 210. The scaled digital signal outputs produced by digital scaling elements 184 and 186 are produced to DAC 188 and DAC 190, respectively, which are operable to convert the received digital signals to continuous waveform signals based in part upon DAC control signal 214 that is received from power control logic block 210. Power control logic block 210 produces DAC control signal 214 and digital scaling signal 212 based upon filtered digital TSSI signal 208 received from low pass filter 206.

In one embodiment of the invention, baseband processor logic 182, gain scaling element 184, gain scaling element 186, power control logic block 210 and low pass filter 206 are all implemented within a single baseband processor integrated circuit. All other circuitry shown in FIG. 5 is external to the baseband processor. In an alternate embodiment, some of the remaining blocks are also formed within the baseband processor. For example, in one embodiment, DAC 188, DAC 190 and ADC 202 are also formed within the baseband processor integrated circuit.

Generally, the transmitter with TX power control circuit 180 is operable to adjust the output of gain scaling element 184 and gain scaling element 186 to increase or decrease a signal magnitude of a signal received by DAC 188 and DAC 190 for the I path and Q path outgoing signals. These adjusted signal magnitudes affect the magnitude of the output of RFIC 192 which, in turn, affects the final magnitude of amplified transmission signal 196. As such, power control logic block 210 operates to control amplified transmission signal 196 to keep amplified transmission signal 196 within a tolerable range and/or a substantially constant value.

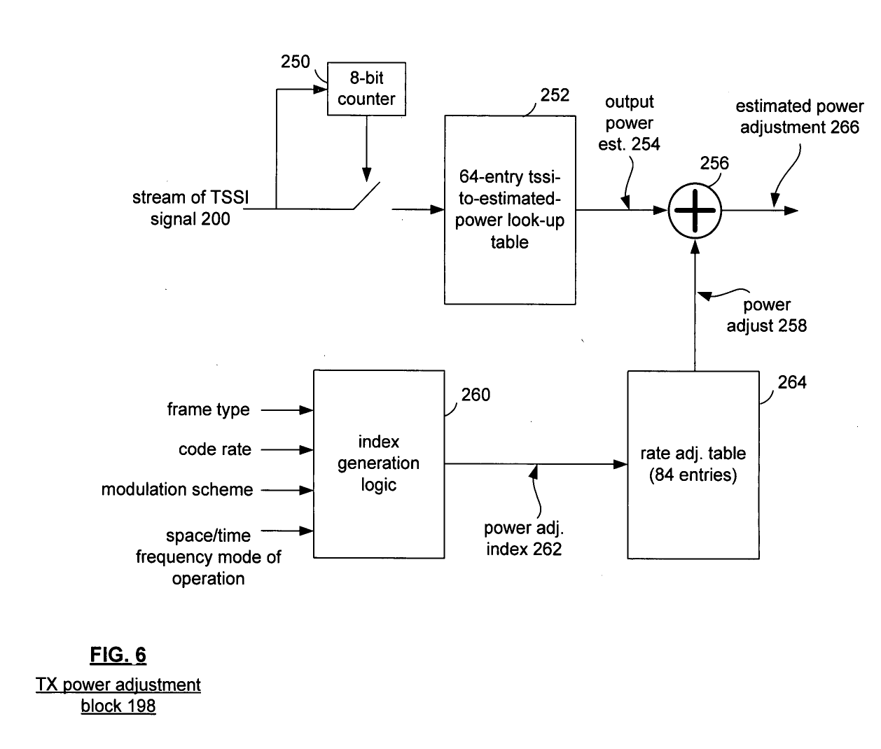

FIG. 6 is a functional block diagram of a transmit power detect block TX power adjustment block 198 according to one embodiment of the invention. TX power adjustment block 198 is operably disposed to receive a stream of TSSI signals 200. A counter 250 is operably disposed to also receive the stream of TSSI signals 200. Upon counting a specified number of TSSI signals 200 from the start of a transmitted frame, counter 250 is operable to close a connection to couple the next TSSI signal 200 to an input of a look-up table 252 and subsequently to re-open the connection until the specified count number has been reached. Thus, only every Nth TSSI signal 200 is produced to look-up table 252 wherein N is equal to the specified count number. It should be understood that other designs for producing a specified portion of the stream of TSSI signals 200 to look-up table 252 may also be implemented. In the embodiment of FIG. 6, the maximum specified count number of counter 250 is limited by the capacity of that 8-bit counter that is utilized as counter 250. Because counter 250 only begins counting upon the initiation of a frame, it cannot be considered to be truly periodic.

Look-up table 252, in the described embodiment, is a 64-entry TSSI-to-estimated power look-up table. Based upon a mapping of TSSI signal 200 values to output power estimates, look-up table 252 produces an output power estimate signal 254 to a compensation element 256. Compensation element 256 is operably connected to also receive a power adjust signal 258 and is operable to adjust output power estimate signal 254 based upon power adjust signal 258.

An index generation logic block 260 is operably disposed to receive an indication of frame type, code rate, modulation scheme and space/time frequency mode of operation. Each of these inputs to index generation logic block 260 are generated by logic within the baseband processor generating the outgoing communication signals whose output power is being monitored and adjusted according to the embodiments of the present invention. Based upon these indications, index generation logic block 260 determines and produces a power adjustment index signal 262. Logic 260 generates power adjustment index signal 262 based on one or more inputs. In the embodiment shown, index generation logic 260 is operably disposed to receive inputs that include frame type, code rate, modulation scheme, and space/time frequency mode of operation. Accordingly, logic 260 generates the index signal 262 based upon values or logic states of each of these inputs. For example, of the 802.11 a/b/g/n protocol transmissions, if the frame type indicates that 802.11b protocol transmissions are being utilized, there are only four possible rates that may be considered. Accordingly, the power adjustment index will be one of four values resulting in one of four potential power adjust signal settings being produced as power adjust signal 258. For OFDM frames, on the other hand, there are multiple different code rates, different modulation types, and different frequency modes of operation. In this example, the number of each of these values may be multiplied to result in a total number of possible power adjustment index 262 values and, therefore, an equivalent total possible power 258 values that compensate for the same number of data rates. For example, if there are 4 code rates, 4 modulation types and 4 frequency modes of operation, then there could be 64 total data rates, 64 power adjustment index values and 64 corresponding power adjustment index values. Thus, logic 260 includes logic for evaluating frame type, code rate, modulation scheme and space/time frequency mode of operation to set a power adjustment index 262.

A rate adjustment table 264 is operably disposed to receive power adjustment index signal 262. Power adjustment index signal 262 is mapped to power adjust values within table 264 that are produced as power adjust signal 258. The power adjust signal 258 is received by compensation element 256 and is therefore based upon power adjustment index signal 262. Compensation element 256, therefore, produces estimated power adjustment signal 266 based upon a sum of output power estimate signal 254 and power adjust signal 258.

In operation, the output transmission power of a transmitting device is typically adjusted based upon many transmission parameters including data or code rate, frame type, modulation scheme and/or space/time frequency mode of operation. Thus, while such factors affect the output transmission power levels, they also must be accounted for in determining how much an output transmission power level should be adjusted to account for fluctuations in output power in order to maintain a substantially constant power level. As such, index generation logic block 260 receives each of these many transmission parameters as a part of generating power adjustment index signal 262 which, in turn, drives which signal is generated as power adjust signal 258. Power adjust signal 258 is subsequently combined with output power estimate signal 254 in compensation element 256 to produce estimated power adjustment signal 266. It is understood, of course that a subset of these transmission parameters may be used to produce power adjustment signal 266. Moreover, other parameters may be used additionally or in place of one or more of these transmission parameters.

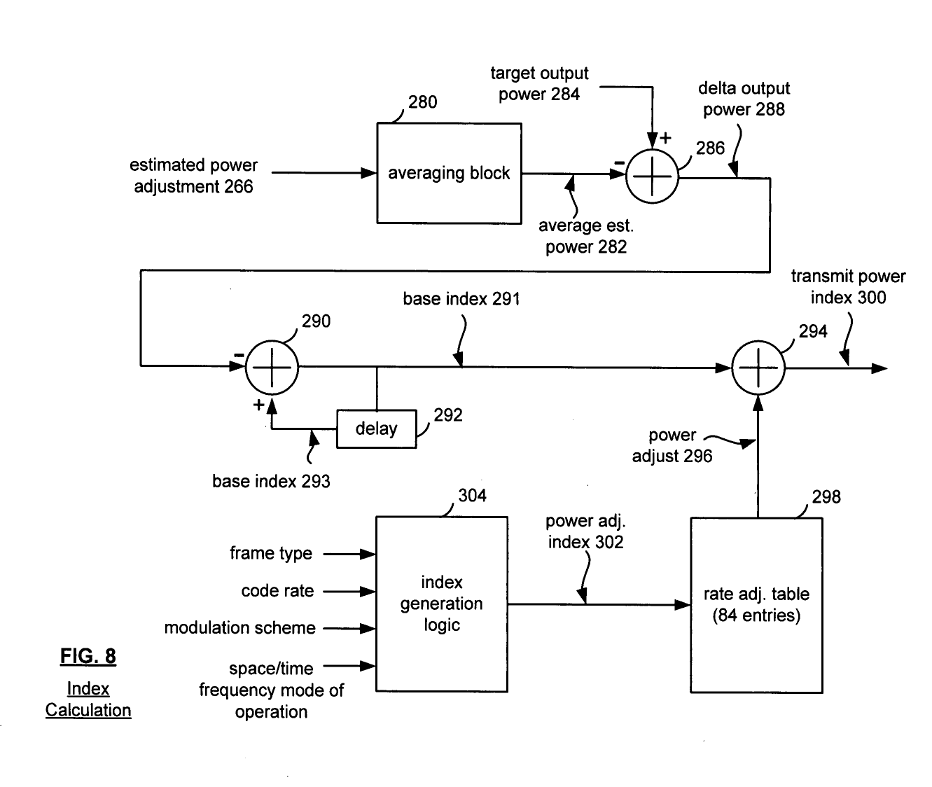

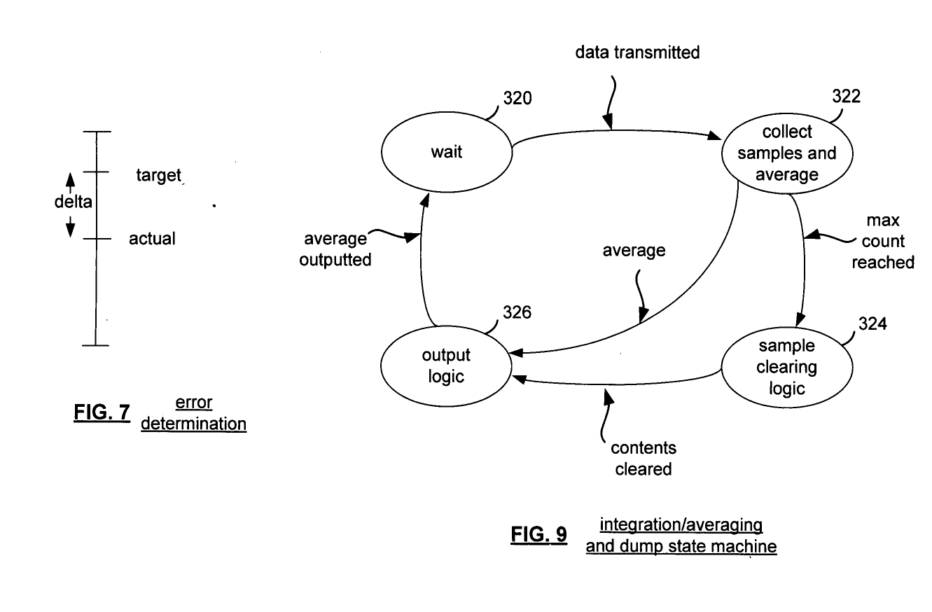

FIG. 7 illustrates one aspect of the embodiments of the present invention. Specifically, FIG. 7 illustrates that a detected power level, after rate based compensation calculations, is compared to a threshold value and a delta value power index value is determined therefrom. The delta value is then added to a prior index value to determine a new power index value for a subsequent set of data frames that are to be transmitted as is described below in relation to FIG. 8.

FIG. 8 is a functional block diagram that illustrates logic for determining a transmit power index according to one embodiment of the invention. Referring to FIG. 8, an averaging block 280 is coupled to receive estimated power adjustment signal 266 and is operable to produce average estimated power signal 282 based upon averaging block 280. In the described embodiment, averaging block 280 is operable to integrate and dump with rounding the stream of signals received as estimated power adjustment signal 266. More generally, however, averaging block 280 is operable to determine an average estimated power by producing a value that represents an average power over a specified number of inputs or over a specified amount of time.

A target output power value 284 is received by a combining element 286. Combining element 286 also receives the average estimated power signal 282 and produces delta output power signal 288, which is based upon average estimated power signal 282, and target output power value 284. In the described embodiment, average estimated power signal 282 is subtracted from target output power value 284 to produce delta output power signal 288.

A combining element 290 is coupled to receive delta output power signal 288 on a pulse by pulse basis and produces base index 291 as an output. A feedback loop from an output of combining element 290 includes a delay element 292, wherein base index 291 is delayed one clock cycle and is then fed back to a positive input of combining element 290. Delay element 292 is thus operable to introduce a one clock delay to the output of combining element 290 (base index 291) back to combining element 290 as a positive input shown as base index 293 which is summed with the negative of delta output power 288 received from combining element 286. The delta output power signal 288, because it is produced as a negative input to combining element 290, is then subtracted from the based index signal 291 produced by delay element 292. Mathematically, this operation may be represented as:
base index(new)=base index(old)−delta output power (1)
wherein old and new represent sequentially clocked values.

The output of combining element 290 is also produced as an input to combining element 294. Combining element 294 combines the output of combining element 290 (base index 291) with a power adjust signal 296 received from rate adjustment table 298 to produce a transmit power index transmit power index signal 300. A rate adjustment table 298 produces power adjust signal 296 based upon a power adjustment index 302 received from index generation logic 304. Index generation logic 304 produces power adjustment index 302 based upon one or more inputs including frame type, code rate, modulation scheme and/or space/time frequency mode of operation. Effectively, the operations of FIG. 8 serve to generate a power adjust signal 296 to generate a transmit power index that accounts for at least one of frame type, code rate, modulation scheme and/or space/time frequency mode of operation.

FIG. 9 is a diagram illustrating a process utilized in one embodiment of the present invention. Specifically, the illustration of FIG. 9 is for an integration/averaging and dump process operable to produce an average of values. Initially, the process, which for example, may be implemented within averaging block averaging block 280 of FIG. 8, includes a wait state 320. Wait state 320 is a state of operation whenever data is not being received. Once data is received, the process transitions to collect and average state 322. The process remains in state collect and average state 322 until a specified number of samples of transmission power levels have been collected and averaged. The specified number can be, for example, 8 samples of transmission power levels. Thereafter, the process then produces an average to output process 326. In addition to providing an average to output process 326, an indication is provided to sample clearing logic 324 to prompt sample clearing logic 324 to clear the collected samples and average value. Once the samples have been cleared or “dumped”, an indication is provided to output process 326. Output process 326 then generates the average value as an output and the process transitions back to wait state 320.

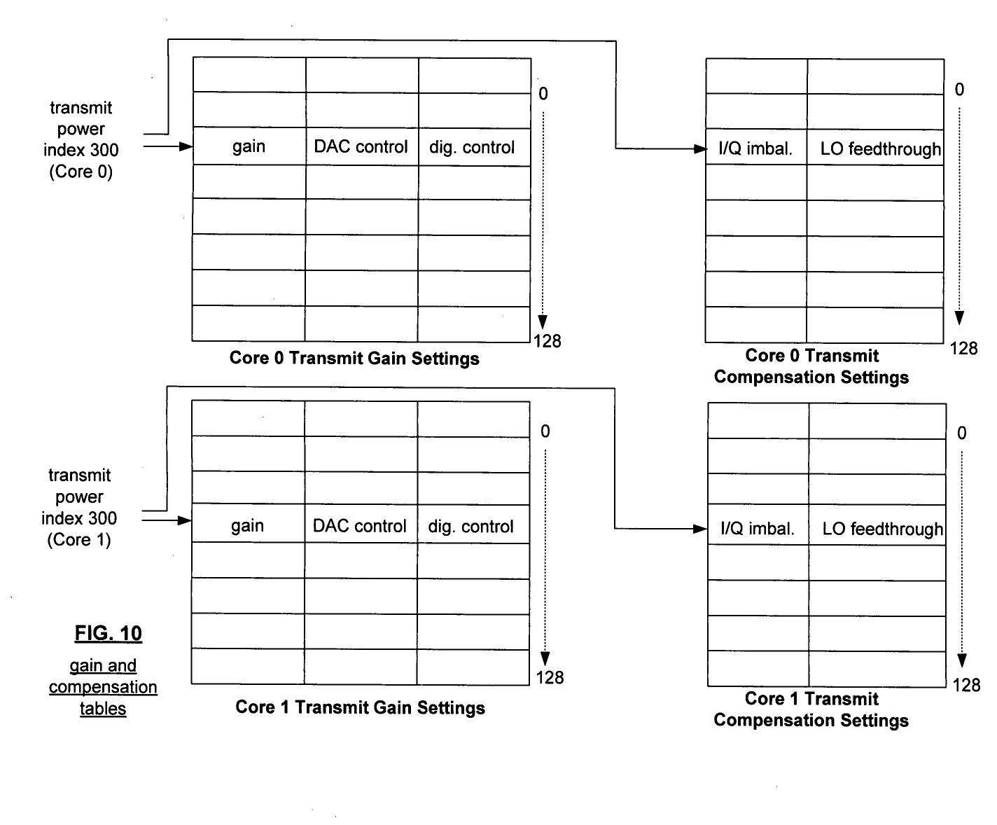

FIG. 10 is a diagram illustrating a method according to one embodiment of the invention for determining transmit gain settings and transmit compensation setting for I/Q imbalance and LO feedthrough according to one embodiment of the invention for one or more cores. It should be understood that the method illustrated in FIG. 10 may be implemented for a single transmit path or for a plurality of transmit paths in a MIMO type radio transceiver. Referring back to FIG. 5, it may be seen that power control logic block 210 generates core select signal 218 to RFIC 192 to select a core for a specified transmission. FIGS. 6-9 illustrate operation within a single core though the embodiments shown may be applied to all cores within a transceiver. FIG. 10 illustrates selection of gain and compensation settings for two cores, namely cores 0 and 1. As may be seen, a transmit power index signal 300 is produced to a set of gain and compensation tables for a selected core. Transmit power index signal 300 is mapped to a specified gain control signal 216, a DAC control signal 214, and a digital scaling signal 212. Transmit power index signal 300 is also mapped to an I/Q imbalance compensation value and an LO feedthrough compensation value. The I/Q imbalance compensation value and LO feedthrough compensation value are used to adjust any one of a number of operational parameters of a radio front end including filtration parameters of low pass filters and gain settings of one or more amplification devices within the radio front. The compensation factors may be included in the specified gain control signal 216, DAC control signal 214 and digital scaling signal 212 or may result in additional control signals not shown herein. Generally, the concepts of I/Q imbalance and LO feedthrough are known by those of average skill in the art.

Other aspects and embodiments of the invention are illustrated in the attached presentation materials. As one of ordinary skill in the art will appreciate, the term “substantially” or “approximately”, as may be used herein, provides an industry-accepted tolerance to its corresponding term and/or relativity between items. Such an industry-accepted tolerance ranges from less than one percent to twenty percent and corresponds to, but is not limited to, component values, integrated circuit process variations, temperature variations, rise and fall times, and/or thermal noise. Such relativity between items ranges from a difference of a few percent to magnitude differences. As one of ordinary skill in the art will further appreciate, the term “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled”.

While the invention is susceptible to various modifications and alternative forms, specific embodiments thereof have been shown by way of example in the drawings and detailed description. It should be understood, however, that the drawings and detailed description thereto are not intended to limit the invention to the particular form disclosed, but, on the contrary, the invention is to cover all modifications, equivalents and alternatives falling within the spirit and scope of the present invention as defined by the claims. As may be seen, the described embodiments may be modified in many different ways without departing from the scope or teachings of the invention.

1. A method of controlling power levels on a plurality of transmit streams in a single radio transceiver, comprising, for each of the plurality of transmit streams:
detecting an output power level and sampling the output power level;
digitizing the sample output power level;
producing the digitized sample to a baseband processor;
within, the baseband processor:
performing rate based compensation on the digital sample;
integrating and dumping a plurality of digitized samples over a period that exceeds a transmission frame period to produce an average value over a specified number of samples;
converting the integrated plurality of digitized samples to a normalized value;
comparing the normalized value to a target value to generate a power index value that will result in the normalized value being substantially equal to the target value;
determining an output power level based upon the power index value; and
performing rate based compensation for the determined output power level.

2. The method of claim 1 wherein performing the rate based compensation includes compensating for constellation type.

3. The method of claim 1 wherein performing the rate based compensation includes compensating for coding rate.

4. The method of claim 1 wherein performing the rate based compensation includes compensating for a number of concurrently transmitting spatial streams.

5. The method of claim 1 further including compensating for I/Q imbalance based upon the power index value.

6. The method of claim 1 further including compensating for LO feedthrough based upon the power index value.

7. A transmitter with transmit power control circuit, comprising:
processing logic operable to produce outgoing communication signals;
radio front end circuitry operable to upconvert outgoing signals to radio frequency;
a power amplifier operable to amplify the outgoing radio frequency signals for transmission to produce an amplified transmission signal;
a power detect block operable to produce a transmit signal strength indication based upon the amplified transmission signal;
power control logic operable to produce a gain control signal and a core select signal to select a core of a plurality of cores for the gain control signal;
wherein the power control logic is further operable to produce a digital-to-analog (DAC) control signal to set operational parameters for the DAC; and
wherein the power control logic is further operable to produce a digital scaling signal to scale a magnitude of the outgoing communication signals produced by the processing logic.

8. The transmitter of claim 7 wherein the power control logic further includes:
an eight bit counter for selecting samples from a stream of transmit signal strength indications (TSSI);
a power look-up table for mapping TSSI values to output power estimates; and
circuitry for adjusting the output power estimates based upon at least one of frame type, code rate, modulation scheme and space/time frequency mode of operation.

9. The transmitter of claim 8 wherein the circuitry for adjusting the output power estimates further includes an index generation logic block that is operably disposed to receive at least one of frame type, code rate, modulation scheme and space/time frequency mode of operation and is operable to produce a transmit power index.

10. The transmitter of claim 9 further including a rate adjustment table that produces the power adjust signal based upon the power adjustment index produced by the index generation logic block.

11. The transmitter of claim 10 further including a first core transmit gain setting table for determining a gain value based upon the transmit power index.

12. The transmitter of claim 10 further including a first core transmit gain setting table for determining a DAC control value based upon the transmit power index.

13. The transmitter of claim 10 further including a first core transmit gain setting table for determining a digital scaling value based upon the transmit power index.

14. The transmitter of claim 10 further including a first core transmit gain setting table for determining an I/Q imbalance compensation value based upon the transmit power index.

15. The transmitter of claim 10 further including a first core transmit gain setting table for determining an LO feedthrough compensation value based upon the transmit power index.

16. A transmitter, comprising:
a transmit power adjustment block operable to produce a power adjust signal;
an index calculation block for producing a transmit power index signal based upon the power adjust signal; and
transmit gain and compensation logic for generating, for a specified core of a plurality of cores having a radio front end for transmitting outgoing RF signals, at least one of a gain control signal, a DAC control signal, a digital scaling signal, an I/Q imbalance compensation signal and an LO feedthrough compensation signal based upon the transmit power index signal

17. The transmitter of claim 16 wherein the transmit power adjustment block further includes:
an eight bit counter for producing selected samples from a stream of transmit signal strength indications (TSSI);
a power look-up table for producing output power estimates based upon the selected TSSI values;
an index generation logic block that is operably disposed to receive at least one of frame type, code rate, modulation scheme and space/time frequency mode of operation and is operable to produce a transmit power adjustment index based upon a combination of at least one of frame type, code rate, modulation scheme and space/time frequency mode of operation;
a rate adjustment table that produces a power adjust signal based upon the power adjustment index produced by the index generation logic block; and
a combining element that produces the estimated power adjustment based upon the output power estimate and the power adjust signal.

18. The transmitter of claim 17 further including a first core transmit gain setting table for determining a gain value based upon the transmit power index for a selected core of a plurality of cores.

19. The transmitter of claim 17 further including a second core transmit gain setting table for determining a gain value based upon the transmit power index for a selected core of a plurality of cores.

20. The transmitter of claim 17 further including a first core transmit gain setting table for determining a gain setting, a DAC control signal and a digital compensation value based upon the transmit power index for a selected core of a plurality of cores.

21. The transmitter of claim 17 further including a first core transmit compensation table for determining an I/Q imbalance compensation value based upon the transmit power index for a selected core of a plurality of cores.

22. The transmitter of claim 18 further including a first core transmit compensation table for determining an LO feedthrough compensation value based upon the transmit power index for a selected core of a plurality of cores.
